(19) United States
(12) Patent Application Publication
(10) Pub. No.: US 2015/0314284 A1
(43) Pub. Date: Nov. 5, 2015

(54) SPECIMEN CONTAINER FOR BIOLOGICAL MATERIALS

(71) Applicant: Francesca Dagny TEKULA, McCordsville, IN (US)

(72) Inventor: Francesca Dagny TEKULA, McCordsville, IN (US)

(21) Appl. No.: 14/703,283

(22) Filed: May 4, 2015

Related U.S. Application Data
(60) Provisional application No. 61/987,577, filed on May 2, 2014.

(51) Int. Cl. B01L 3/00

(52) U.S. Cl. CPC B01L 3/502; B01L 3/565; B01L 3/561; B01L 2300/042; B01L 2300/0832; B01L 2300/087; B01L 2400/0478; B01L 2200/18

(57) ABSTRACT

A specimen container for use with biological specimens that includes at least one cylindrical housing, wherein the at least one cylindrical housing is open on one or both ends thereof, at least one cap for sealing the open ends of the at least one cylindrical housing; a syringe plunger adapted for insertion into the at least one cylindrical housing, wherein the syringe plunger is operative to move a biological specimen into the at least one cylindrical housing when the syringe plunger is depressed; and optionally, a linking cuff, wherein the linking cuff is operative to join multiple cylindrical housings to one another and permit mixing of the contents thereof.

### CROSS-REFERENCE TO RELATED APPLICATIONS

This patent application claims the benefit of U.S. Provisional Patent Application Ser. No. 61/987,577 filed on May 2, 2014 and entitled “Specimen Container for Biological Materials,” the disclosure of which is hereby incorporated by reference herein in its entirety and made part of the present U.S. utility patent application for all purposes.

### BACKGROUND OF THE INVENTION

The described invention relates in general to a containers for use with biological specimens and samples, and more specifically to a container for use with bone samples harvested from living patients. Proper collection and preparation of bone marrow is critical to the study of a variety of hematologic and neoplastic disorders. Dry bone core samples will desiccate and be useless for any study, including slides/morphology. Thus, there is an ongoing need for a container that may be used to effectively store and transport bone samples or other biological materials without damaging or otherwise rendering useless the sample.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first specimen container is provided. This specimen container includes at least one cylindrical housing, wherein the at least one cylindrical housing is open on one or both ends thereof; at least one cap for sealing the open ends of the at least one cylindrical housing; a syringe plunger adapted for insertion into the at least one cylindrical housing, wherein the syringe plunger is operative to move a biological specimen into the at least one cylindrical housing when the syringe plunger is depressed; and optionally, a linking cuff, wherein the linking cuff is operative to join multiple cylindrical housings to one another and permit mixing of the contents thereof.

In accordance with another aspect of the present invention, a second specimen container is provided. This specimen container includes a first cylindrical housing section, wherein the first cylindrical housing is adapted to receive a plunger, and wherein the first cylindrical housing section is threaded on one or both ends thereof; a second cylindrical housing section, wherein the second cylindrical housing section is threaded on both ends thereof; a threaded linking cuff for connecting the first and second cylindrical housing sections to one another; a plunger adapted for insertion into the first cylindrical housing section, wherein the plunger is operative to move a biological specimen into the first cylindrical housing section when the syringe plunger is depressed; and a cap for sealing the end of the second cylindrical housing section opposite the end attached to the first cylindrical housing section.

In yet another aspect of this invention, a third specimen container is provided. This specimen container includes a first cylindrical housing section, wherein the first cylindrical housing is adapted to receive a plunger, wherein the first cylindrical housing section is threaded on both ends thereof, and wherein the first cylindrical housing section further includes wing structures formed thereon; a second cylindrical housing section, wherein the second cylindrical housing is adapted to receive a plunger, wherein the second cylindrical housing section is threaded on both ends thereof, and wherein the second cylindrical housing section further includes wing structures formed thereon; a threaded linking cuff for connecting the first and second cylindrical housing sections to one another; a plunger adapted for insertion into either the first or second cylindrical housing section, wherein the plunger is operative to move a biological specimen into the first or second cylindrical housing section when the plunger is depressed; and at least one cap for closing and sealing either of the cylindrical housing sections.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is an exploded, perspective view of a specimen container in accordance with an exemplary embodiment of the present invention.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to container for storing and transporting biological specimens and samples, and more specifically to a container for storing, transporting, and preserving bone samples (and/or other cell or tissue specimens) that includes at least one cylindrical housing, wherein the at least one cylindrical housing is open on one or both ends thereof; at least one cap for completely sealing the open ends of the at least one cylindrical housing; a syringe plunger adapted for insertion into the at least one cylindrical housing, wherein the syringe plunger is operative to move a biological specimen further into the at least one cylindrical housing when the syringe plunger is depressed; and optionally, a linking cuff, wherein the linking cuff is operative to join multiple cylindrical housings to one another and permit mixing of the contents thereof with demineralized bone matrix (DBM) or other materials and compositions, per the choice of the surgeon using the container.

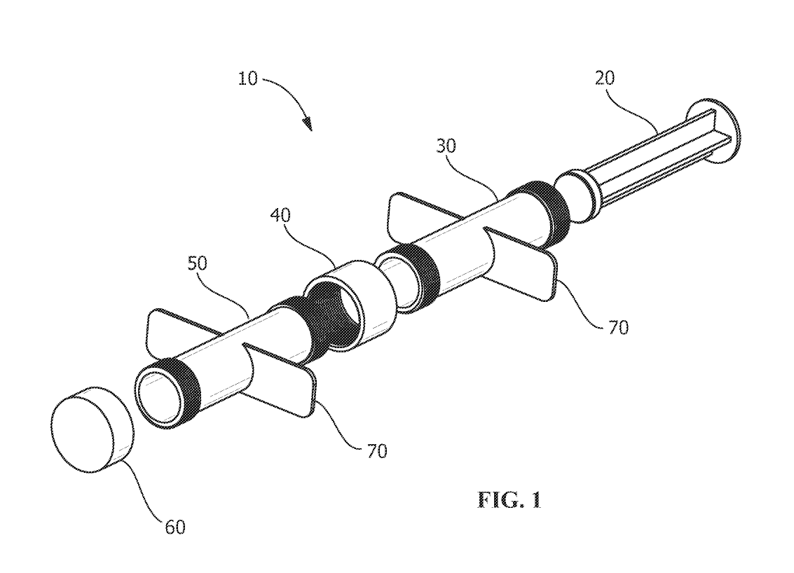

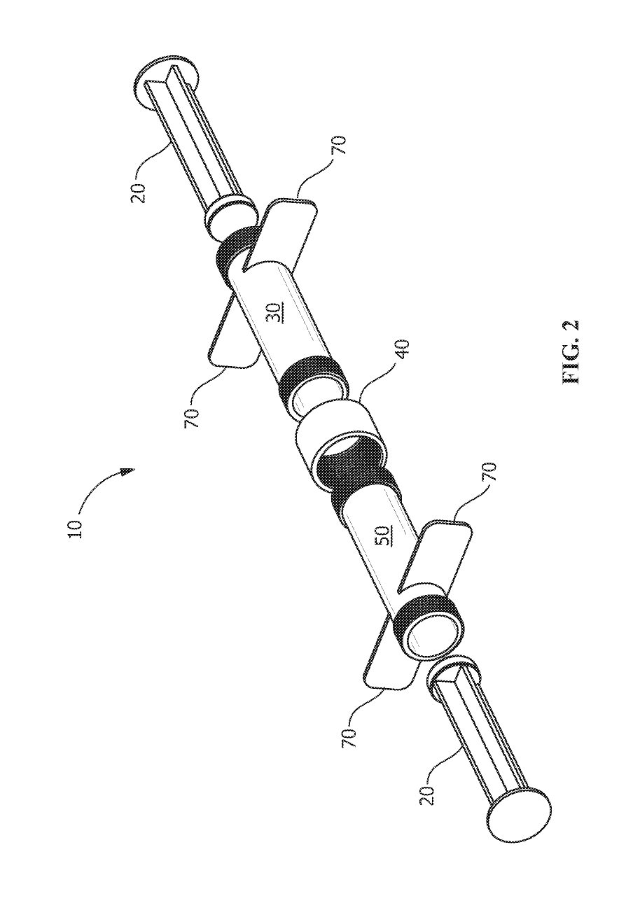

FIG. 1 is an exploded, perspective view of a specimen container in accordance with an exemplary embodiment of the present invention. In FIG. 1, container 10 includes plunger 20, first housing section 30, which is threaded on both ends thereof; threaded linking cuff 40; second housing section 50, which is also threaded on both ends thereof; and threaded cap 60. Housing sections 30 and 50 also include wing structures 70, which provide gripping surfaces that facilitate depression of plunger 20, when in use. In some embodiments, only one housing section is used and cap 60 is threaded onto the end of housing section 30 opposite the end into which plunger 20 is inserted. In other embodiments, two or more housing sections are joined together for mixing the contents thereof or for simply increasing the volume thereof. When multiple housing sections are used, threaded linking cuff 40 is used to attach the sections to one another, O-rings, gaskets, or other rubberized components may be included to enhance the sealing properties of container 10 and to more effectively join the components thereof to one another.

Each cylindrical housing, as well as the caps and cuffs, may be manufactured from any variety of materials that are suitable tier storing and transporting biological materials and each housing may be graduated for providing the user with an indication of the amount of material stored in each container, The container may be provided in 5 and 10 cc sizes, although other dimensions and volumes are possible. The containers of the present invention are typically provided as sterile devices and various stabilizers and/or preservatives may be pre-loaded into the containers, if appropriate and/or desirable.

While the present invention has been illustrated by the description of exemplary embodiments thereof and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A specimen container for use with biological specimens, comprising:
(a) at least one cylindrical housing, wherein the at least one cylindrical housing is open on one or both ends thereof;
(b) at least one cap for sealing the open ends of the at least one cylindrical housing;
(c) a syringe plunger adapted for insertion into the at least one cylindrical housing, wherein the syringe plunger is operative to move a biological specimen into the at least one cylindrical housing when the syringe plunger is depressed; and
(d) optionally, a linking cuff, wherein the linking cuff is operative to join multiple cylindrical housings to one another and permit mixing of the contents thereof.

2. The specimen container of claim 1, wherein the at least one cylindrical lousing is graduated.

3. The specimen container of claim 1, wherein the at least one cylindrical housing further includes wing structures formed thereon, and wherein the wing structures provide gripping surfaces for facilitating the depression of the syringe plunger.

4. The specimen container of claim 1, wherein the end portions of the at least one cylindrical housing are threaded.

5. The specimen container of claim 1, wherein the volume of the at least one cylindrical housing is about 5 cc to 10 cc.

6. A specimen container for use with biological specimens, comprising:
(a) a first cylindrical housing section, wherein the first cylindrical housing is adapted to receive a plunger, and wherein the first cylindrical housing section is threaded on one or both ends thereof;
(b) a second cylindrical housing section, wherein the second cylindrical housing section is threaded on both ends thereof;
(c) a threaded linking cuff for connecting the first and second cylindrical housing sections to one another;
(d) a plunger adapted for insertion into the first cylindrical housing section, wherein the plunger is operative to move a biological specimen into the first cylindrical housing section when the syringe plunger is depressed; and
(e) a cap for sealing the end of the second cylindrical housing section opposite the end attached to the first cylindrical housing section.

7. The specimen container of claim 6, wherein at least one of the cylindrical housing sections is graduated.

8. The specimen container of claim 6, wherein at least one of the cylindrical housing sections further includes wing structures formed thereon, and wherein the wing structures provide gripping surfaces for facilitating the depression of the syringe plunger.

9. The specimen container of claim 6, wherein the volume of each cylindrical housing section is about 5 cc to 10 cc.

10. The specimen container of claim 6, wherein the plunger is a syringe plunger.

11. A specimen container for use with biological specimens, comprising:
(a) a first cylindrical housing section, wherein the first cylindrical housing is adapted to receive a plunger, wherein the first cylindrical housing section is threaded on both ends thereof, and wherein the first cylindrical housing section further includes wing structures formed thereon;
(b) a second cylindrical housing section, wherein the second cylindrical housing is adapted to receive a plunger, wherein the second cylindrical housing section is threaded on both ends thereof and wherein the second cylindrical housing section further includes wing structures formed thereon;
(c) a threaded linking cuff for connecting the first and second cylindrical housing sections to one another;
(d) at least one plunger adapted for insertion into either the first or second cylindrical housing section, wherein the at least one plunger is operative to move a biological specimen into the first or second cylindrical housing section when the at least one plunger is depressed; and
(e) at least one cap for closing and sealing the open end of either of the cylindrical housing sections.

12. The specimen container of claim 11, wherein both of the cylindrical housing sections are Graduated.

13. The specimen container of claim 11, wherein the volume of each cylindrical housing section is about 5 cc to 10 cc.

14. The specimen container of claim 11, wherein the plunger is a syringe plunger.

15. The specimen container of claim 11, further comprising at least one O-ring for providing a seal between the components of the container.

16. The specimen container of claim 11, further comprising a plurality of O-rings for providing seals between the components of the container.
